(19) United States
(12) Patent Application Publication
(10) Pub. No.: US 2026/0359108 A1
(43) Pub. Date: Nov. 12, 2026

(54) APPLICATION PROGRAMMING INTERFACE LIMIT BASED JOB SCHEDULER

(71) Applicant: Rubrik, Inc., Palo Alto, CA (US)

(72) Inventors: Anshul Gupta, Mountain View, CA (US); Suman Swaroop, San Francisco, CA (US)

(21) Appl. No.: 19/200,373

(22) Filed: May 6, 2025

(51) Int. Cl. G06F 9/48

(52) U.S. Cl. CPC G06F 9/4881; G06F 2209/486

(57) ABSTRACT

Methods, systems, and devices for data management are described. A data management system (DMS) may provide backup and recovery services of data stored on a software-as-a-service (SaaS) application for a customer of the DMS. The DMS may obtain an indication of a first quantity of application programming interface (API) calls allocated to the DMS in association with the customer for the SaaS application over a rolling duration. The DMS may obtain, from a data store, an indication of a second quantity of API calls used by the DMS during a first rolling time period of the rolling duration. The DMS may schedule a job associated with backup or recovery service for the SaaS application in association with the customer based on the second quantity of API calls being less than a first threshold quantity. The first threshold quantity may be based on the first quantity of API calls.

### FIELD OF TECHNOLOGY

The present disclosure relates generally to data management, including techniques for application programming interface limit based job scheduler.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports application programming interface (API) limit based job scheduler in accordance with aspects of the present disclosure.

FIG. 2 shows an example of a system diagram that supports an API limit based job scheduler in accordance with aspects of the present disclosure.

FIG. 3 shows an example of a communication timeline that supports an API limit based job scheduler in accordance with aspects of the present disclosure.

FIG. 4 shows an example of a process flow that supports an API limit based job scheduler in accordance with aspects of the present disclosure.

FIG. 5 shows a block diagram of an apparatus that supports an API limit based job scheduler in accordance with aspects of the present disclosure.

FIG. 6 shows a block diagram of a job scheduling component that supports an API limit based job scheduler in accordance with aspects of the present disclosure.

FIG. 7 shows a diagram of a system including a device that supports an API limit based job scheduler in accordance with aspects of the present disclosure.

FIGS. 8 through 10 show flowcharts illustrating methods that support an API limit based job scheduler in accordance with aspects of the present disclosure.

### DETAILED DESCRIPTION

A data management system (DMS) may provide backup and recovery service for customer data on a software platform (e.g., a software-as-a-service (SaaS) application). The DMS may access the data on the software platform (e.g., the SaaS application) to provide the backup and recovery services by outputting application programming interface (API) calls to the software platform. The software platform (e.g., the SaaS application) may limit a total quantity of API calls that can be made in a time period by a particular customer of the software platform (e.g., the SaaS application), which may be the customer of the DMS. For example, a customer may be limited to a quantity of API calls within a day, within a week, or within a month for a given software platform or SaaS application. The time period may be a rolling time period (e.g., the customer may be limited to x quantity of API calls within a rolling 24 hour window). As another example, the time period may be a calendar time period. For example, the customer may be limited to x quantity of API calls within a single calendar day, and the quantity may reset each calendar day. As another example, the customer may be limited to x quantity of API calls every hour, and the quantity may reset on the hour every hour (e.g., reset at 1:00 am, reset at 2:00 am, reset at 3:00 am, etc.). The customer may allocate a percentage (e.g., portion) of the total quantity of API calls per time period to the DMS (e.g., to the backup and recovery services provided by the DMS). The customer may allocate additional percentages of the total quantity of API calls to other use cases (e.g., for normal operation of the software platform or SaaS application). If the customer exceeds the quantity of total API calls within the time period, the software platform (e.g., the SaaS application) may throttle or block API calls made by the customer. The DMS may perform backup and recovery services for a given customer via performance of multiple jobs (e.g., thousands of jobs). The multiple jobs may each output multiple API calls and may be distributed across multiple computing systems (e.g., nodes).

According to techniques described herein, the DMS may track the quantity of API calls used by the DMS for backup and recovery services for a software platform (e.g., a SaaS application) associated with a customer to prevent the DMS from exceeding the allocated quantity of API calls for that customer. For example, a job of the DMS may periodically publish a quantity of API calls used by the job to a data store at the DMS or accessible to the DMS (e.g., a central database). Before initiating a new job, the DMS may confirm, based on the data store, that one or more quantities of API calls used within the defined time period are less than one or more allowable thresholds. For example, the DMS may check if a quantity of API calls used by the DMS within the defined time period is less than a first threshold corresponding to a percentage of the total API calls allocated by the customer to the DMS (e.g., 95% of the API calls allocated to the DMS). Additionally, or alternatively, the DMS may check if a quantity of API calls used by the customer as a whole is less than a second threshold corresponding to a percentage of the total quantity of API calls (e.g., 95% of the total quantity of API calls allocated to the customer as a whole). If the quantity of API calls does not satisfy the one or more thresholds, the DMS may postpone initiating the new job. Additionally, or alternatively, once a job is scheduled, before the job outputs an API call to the software platform (e.g., the SaaS application), the job may check if a quantity of API calls used by the DMS within the defined time period is less than the quantity of API calls allocated to the DMS. Additionally, or alternatively, the job may check if a quantity of API calls used by the customer as a whole is less than the total quantity of API calls allocated to the customer by the software platform (e.g., the SaaS application) before the job outputs an API call to the software platform (e.g., the SaaS application). If the quantities of API calls (e.g., the quantity of API calls by the DMS and the total quantity of API calls associated with the customer) within the defined time period satisfy (e.g., are less than) the one or more API limits, the job may output the API call. Contrarily, if the quantities of API calls do not satisfy the one or more API limits, the job may pause (e.g., may refrain from outputting the API call until time passes making additional API calls available).

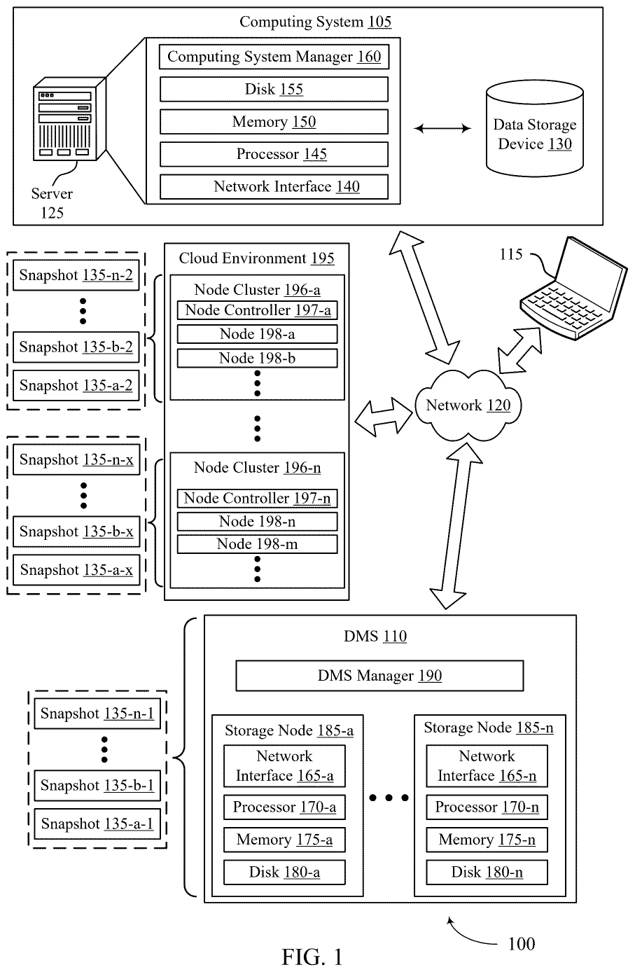

FIG. 1 illustrates an example of a computing environment 100 that supports an API limit based job scheduler in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through SaaS or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

According to techniques described herein, the DMS 110 may track the quantity of API calls used by the DMS 110 for backup and recovery services for a software platform (e.g., a SaaS application) associated with a customer (e.g., stored on one or more servers 125) to prevent the DMS 110 from exceeding the allocated quantity of API calls for that customer for the software platform. For example, a job of the DMS 110 may periodically publish a quantity of API calls used by the job to a data store at or accessible to the DMS 110. Before initiating a new job, the DMS 110 may confirm, based on the data store, that one or more quantities of API calls used within the defined time period are less than one or more allowable thresholds. For example, the DMS 110 may check if a quantity of API calls used by the DMS 110 within the defined time period is less than a first threshold corresponding to a percentage of the total API calls allocated by the customer to the DMS 110 (e.g., 95% of the API calls allocated to the DMS 110). Additionally, or alternatively, the DMS 110 may check if a quantity of API calls used by the customer as a whole is less than a second threshold corresponding to a percentage of the total quantity of API calls (e.g., 95% of the total quantity of API calls allocated to the customer as a whole). If the quantity of API calls does not satisfy the one or more thresholds, the DMS 110 may postpone initiating the new job. Additionally, or alternatively, once a job is scheduled, before the job outputs an API call, the job may check if a quantity of API calls used by the DMS 110 within the defined time period is less than the quantity of API calls allocated to the DMS 110. Additionally, or alternatively, the job may check if a quantity of API calls used by the customer as a whole is less than the total quantity of API calls allocated to the customer by the software platform (e.g., the SaaS application). If the quantities of API calls (e.g., the quantity of API calls by the DMS 110 and the total quantity of API calls associated with the customer) within the defined time period satisfy (e.g., are less than) the one or more API limits, the job may output the API call. Contrarily, if the quantities of API calls do not satisfy the one or more API limits, the job may pause (e.g., may refrain from outputting the API call until time passes making additional API calls available).

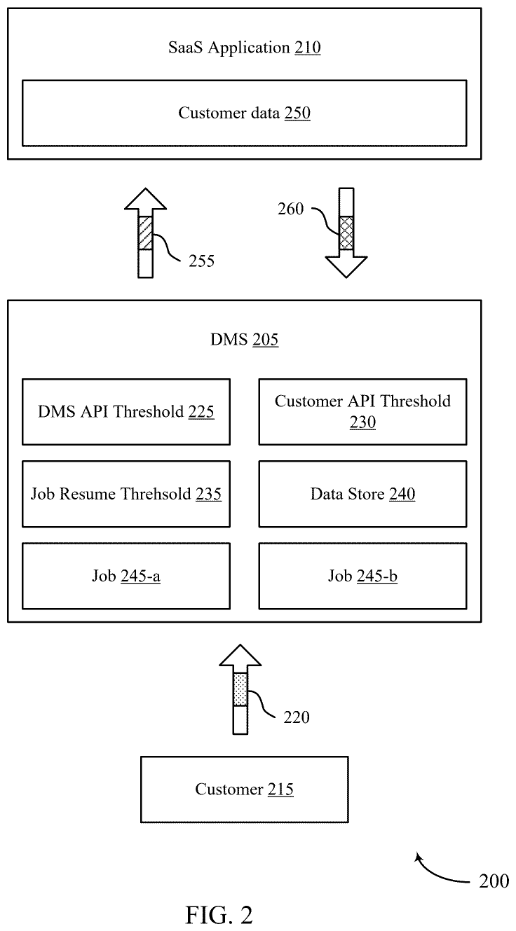

FIG. 2 shows an example of a system diagram 200 that supports an API limit based job scheduler in accordance with aspects of the present disclosure. The system diagram 200 may implement or be implemented by aspects of the computing environment 100 described with reference to FIG. 1. For example, the system diagram 200 may include a DMS 205, which may be an example of a DMS 110 as described with reference to FIG. 1. The DMS 205 may perform API call tracking for backup and recovery services for a software platform (e.g., a SaaS application 210) associated with a customer 215 to prevent the DMS 205 from exceeding an allocated quantity of API calls for that customer 215. For example, the DMS 205 may receive an indication of an API allocation 220 via the customer 215 (e.g., via a computing device associated with an administrative user associated with the customer). The API allocation 220 may indicate a total quantity of API calls allocated to the customer 215 by the SaaS application 210 (e.g., a customer API threshold 230) and/or a quantity of API calls allocated to the DMS 205 by the customer 215 (e.g., a DMS API threshold 225). The DMS API threshold 225 may be a portion of the customer API threshold 230 (e.g., the customer 215 may allocate a portion of the total quantity of API calls to the DMS 205). The DMS 205 may obtain and back up the customer data 250 by outputting one or more API calls 255 to the SaaS application 210 (e.g., for the customer data 250) and receiving one or more API responses 260 from the SaaS application 210 (e.g., for the customer data 250). The DMS 205 may perform the backup and recovery services via one or more jobs 245 (e.g., a job 245-a and a job 245-b). Although shown as two jobs 245, DMS 205 may include any quantity of jobs 245 (e.g., dozens, hundreds, thousands, or millions of storage jobs 245).

The DMS 205 may provide backup and recovery services for one or more SaaS applications 210. The DMS 205 may consume or otherwise use API calls 255 of the SaaS application 210 on behalf of the customer 215. For example, a backup job may involve one or more API calls 255 requesting customer data 250 and one or more corresponding API responses 260 with the requested customer data 250. As another example, a restore job may involve one or more API calls 255 that push backed up customer data 250 to the SaaS application 210 and/or one or more API responses 260 confirming or acknowledging the API calls 255. The SaaS application 210 may limit a quantity of API calls that the customer 215 (e.g., or services on behalf of the customer) may make within a time period (e.g., per day). Different SaaS applications 210 may have different API call policies. In some examples, the customer 215 (e.g., via a computing device associated with an administrative user associated with the customer) may provide account information associated with the customer for the SaaS application 210 (e.g., login credentials such as account name and password information) which the DMS 205 may use to perform the API calls 255 to obtain the information to be backed up. The customer API threshold 230 or the time period may vary for different SaaS applications 210. Additionally, or alternatively, the customer 215 may request the DMS 205 to use a percentage of a total quantity of API calls available to the customer 215. The DMS 205 may ensure that jobs 245 scheduled by the DMS 205 adhere to the API call limits. However, the DMS 205 may be unaware of how many API calls 255 a job 245-a may consume before scheduling the job 245.

The DMS 205 may provide backup and recovery services for a specific SaaS application 210 (e.g., an SaaS organization) through a quantity of jobs 245. The jobs 245 may include backup jobs, discovery jobs, post processing jobs, or restore jobs. The jobs 245 may be on demand or may be periodic and may work concurrently in a distributed manner (e.g., may operate across multiple nodes of the DMS 205).

The SaaS application 210 may set different API limits for different API types for the customer 215. If the customer 215 exceeds the API limit the SaaS application 210 may start failing the API calls 255 made by or on behalf of the customer 215. Failing the API calls 255 may stop customers 215 from accessing the SaaS application and performing business operations. These API limits may be shared by multiple applications and users running on a computing system of the customer 215, which may include the DMS 205. The customer 215 may allocate a percentage of an API call limit (e.g., a maximum quantity of API calls) allocated to the customer 215 to the DMS 205. To prevent the SaaS application 210 from failing the API calls 255, the DMS 205 may adhere to the allocated percentage of API calls 255.

In some examples, a rolling duration, for which the API limits are measured, may be 24 hours. The SaaS application 210 may limit a quantity of API calls made by or on behalf of the customer 215 during a rolling time period of the rolling duration. Although described with reference to a rolling duration, the techniques described herein may also be applied to scenarios where API limits are provided for fixed time durations that reset at fixed time instances (e.g., a 24 hour duration that resets every day at 12:00 am, a 1 hour duration that resets on the hour every hour). The SaaS application 210 may limit a first type of API call performed by the customer 215 to a first quantity (e.g., BULK APIs—15,000 per 24 hours), and a second type of API calls performed by the customer 215 to a second quantity (e.g., REST APIs—500,000 per 24 hours) during the rolling duration. The customer 215 may allocate a percentage of the first quantity (e.g., BULK APIs<=50% of total APIs) and a percentage of the second quantity (e.g., REST APIs<=20% of total APIs) to the DMS 205. For example, the customer 215 may limit the first type of API calls performed by the DMS 205 to a third quantity (BULK—15,000*50%=7,500 per day or per rolling 24 hour window) and the second type of API calls performed by the DMS 205 to a fourth quantity (e.g., REST—500,000*20%=100,000 per day or per rolling 24 hour window).

The SaaS application 210 may support a query for the current API call utilization and a total limit of various API call types (e.g., REST and BULK). For example, the SaaS application 210 may expose an API endpoint which the customer 215 (and the DMS 205 using the customer's credentials) may query to query for the current utilization by the customer of different types of APIs (e.g., the limit and usage of all APIs by the customer, the limit and usage of REST APIs by the customer, the limit and usage of BULK APIs by the customer).

An API response 260 from the query may return a total API utilization for the customer 215 (e.g., a particular organization). The API response 260 may not return the API utilization for a particular application (e.g., backup and recovery services provided by the DMS 205. The DMS 205 may not be able to query the SaaS application 210 for a utilization of a particular application.

In some examples, the DMS 205 may track API calls invoked by the DMS 205 (e.g., via the data store 240), and the DMS 205 may use the tracked API call information to inform a strategy for backing off or throttling jobs 245 when utilization exceeds an allocation proved by the customer 215. Although shown as included in the DMS 205, the data store 24—may be external to the DMS 205 and may be accessible to the DMS 205. As described herein, in some examples, the DMS 205 may be distributed across multiple computing nodes and/or may be implemented at a cloud environment. In some examples, a user of the customer 215 may input a threshold or percentage of the total API calls allocated to the customer 215 into a user interface (e.g., via a computing device 115 as described with reference to FIG. 1). A DMS API threshold 225 may be the percentage multiplied by a total API call limit for the customer on the SaaS application 210.

The DMS 205 may confirm that the jobs 245 adhere to the API limits set by the customer 215 (in some cases, with a relatively small variance (e.g., 5%)). Additionally, or alternatively, the DMS 205 may temporarily stop using API calls 255 if the current usage of the customer 215 is greater than a customer API threshold 230 (e.g., greater than 95% of the API calls used by the customer). For example, other applications or services performed by or on behalf of the customer 215 may use more than an allocation of API calls indicated by the customer 215. An overall usage may expire even though the DMS 205 has not exceeded the allocation of API calls indicated by the customer for the DMS 205 (e.g., the quota provided for the DMS). The DMS 205 may determine the overall usage for the customer 215 based on an API call to the exposed API endpoint that is available to query customer API limits and usage, as described herein. The DMS 205 may notify the customer 215 if other applications or services exceed an allocation of API calls indicated by the customer 215.

To enforce the API limits, the DMS 205 may monitor the quantity of API calls at two phases. In a first phase for offline jobs 245 (e.g., jobs 245 that have not yet been scheduled), the DMS 205 may not schedule a particular job 245 (if a quantity of used API calls within the rolling time duration is beyond a threshold (e.g., may delay scheduling the job 245 until time has elapsed so that the quantity of used API calls within the rolling time duration is below the threshold). For example, the DMS 205 may not schedule a job if a quantity of API calls within the rolling time duration used by the DMS 205 exceeds the DMS API threshold 225 and/or a quantity of API calls used by the customer exceeds the customer API threshold 230. In a second phase for online jobs 245 (e.g., jobs 245 that have been scheduled and are being executed), the DMS 205 may pause a job 245 that is scheduled or currently being executed if a quantity of used API calls within the rolling time duration exceeds the API limit(s) (e.g., a limit is exceeded while the job 245 is running). For example, the DMS 205 may pause a job if a quantity of API calls used by the DMS 205 within the rolling time duration exceeds the limit of API calls for the DMS 205 or if a quantity of API calls used by the customer 215 exceeds the limit of API calls for the customer 215. The two phased approach including both offline and online API limit restrictions with different thresholds may enforce the API limit policy set by the customer 215 in a distributed environment.

In an illustrative example, the DMS 205 may record the API limits set by customer 215 (e.g., in a database or the data store 240). The API limits may indicate a quantity of API calls that the DMS 205 may use in a rolling duration (e.g., within 24 hours). The DMS 205 may keep track of API counts used by the DMS 205 in the data store 240. For example, each job 245 may publish data to the data store 240 (e.g., a central RSC database) periodically.

In some examples, when initiating each job 245, the DMS 205 may schedule the job if respective quantities of API calls are less than respective thresholds. For example, before scheduling the job 245-a, the DMS 205 may check that an API call usage of the DMS 205 is less than the DMS API threshold 225. For example, the DMS 205 may check that the API call usage of the DMS 205 is less than 95% of the API limit for the DMS 205. Additionally, or alternatively, the DMS 205 may ensure an API usage of the customer 215 (e.g., a usage in an organization) is less than the customer API threshold 230. For example, the DMS 205 may output an API call 255 to the SaaS application 210 requesting an indication of the API usage of the customer 215. The SaaS application 210 may output an API response 260 indicating the API usage of the customer 215 in response to the API call 255. The API response 260 may indicate a quantity of API calls used by the customer 215 during a rolling timer period. The DMS 205 may check that the API call usage of the customer 215 is less than 95% of the overall API limit for the customer 215. While described as 95%, 95 is an exemplary percentage, and any percentage may be used in implementation.

In some cases (e.g., if there are multiple API types), API calls of some API types may be used by some jobs 245 and API calls of other API types may not be used by some jobs 245. The DMS 205 may start the job 245-a with an allowed API type field (e.g., allowedAPITypes) indicating to the job 245-a which APIs are permitted to be used (for example, the job 245-a may be allowed to use REST APIs based on the threshold for the quantities of REST APIs not being exceeded within the rolling time duration but the job 245-a may not be allowed to use BULK APIs based on the threshold for the quantities of BULK APIs being exceeded within the rolling time duration). The DMS 205 may schedule the job 245-a or may not schedule the job 245-a based on API types that may be used by the job 245-a. In some examples, if one or more API types used by the job 245-a are allowed, the DMS 205 may schedule the job 245-a. In some examples, if the one or more API types used by the job 245-a are not allowed, the DMS 205 may not schedule the job 245-a.

During execution of the job 245-a (e.g., within the job 245-a), the DMS 205 may track a current usage of API calls used by the DMS 205 by periodically refreshing or obtaining the current usage of API calls from the data store 240. The DMS 205 may store an indication of the API call usage of the DMS 205 in a cached entry. The job 245-a may obtain or reference the API call usage of the DMS 205 by obtaining the indication in the cached entry. The job 245-a may periodically publish API calls used by the job 245-a to the data store 240. Prior to calling the API, the DMS 205 may determine if the API call satisfies an API call policy. For example, if the API limit for the DMS 205 is breached, the DMS 205 may pause the job 245-a and retry or resume the job 245-a after the API limits satisfies the job resume threshold 235 (e.g., the current usage of API calls in a rolling time period is within 5% the API limit of the DMS 205). Additionally, or alternatively, the DMS 205 may clean up an API usage table in the data store 240 periodically to garbage collect entries.

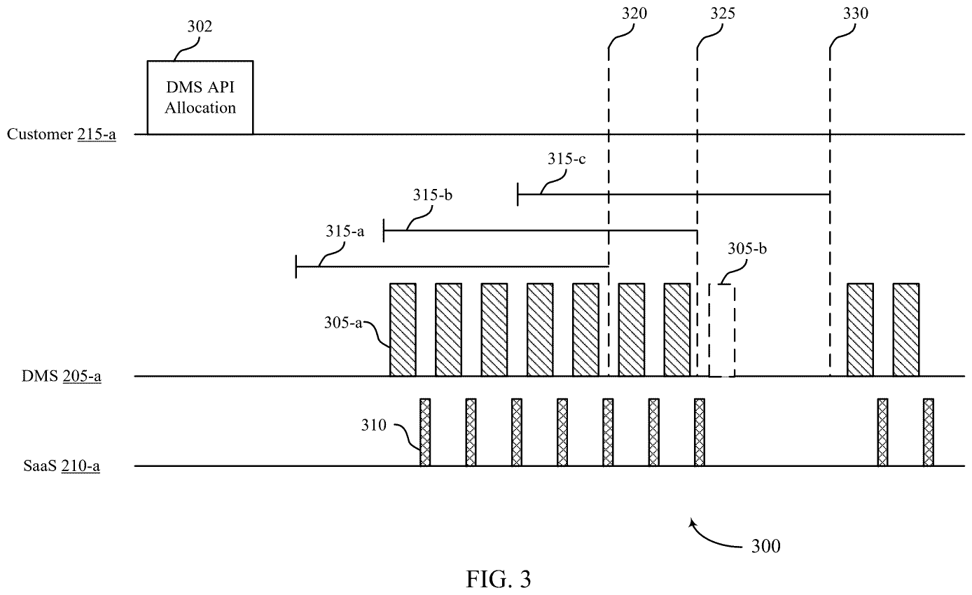

FIG. 3 shows an example of a communication timeline 300 that supports an API limit based job scheduler in accordance with aspects of the present disclosure. The communication timeline 300 may implement or be implemented by aspects of the computing environment 100 described with reference to FIG. 1 or the system diagram 200 described with reference to FIG. 2. For example, a DMS 205-a, an SaaS application 210-a, or a customer 215-a may be examples of a DMS 205, an SaaS application 210, or a customer 215, respectively, as described herein with reference to FIGS. 1 and 2. The SaaS application 210-a may be an example of a software platform via which data is accessed via API calls and responses. The DMS 205-a may perform one or more API calls 305 and obtain one or more API responses 310 for providing backup and recovery services for a customer 215-a.

At 302, the customer 215-a (e.g., an administrative user of the customer 215-a) may provide an indication of a DMS API allocation. For example, the user of the customer 215-a may input a percentage of a total API call limit via user interface which may be provided to the DMS 205-a. The DMS 205-a may store the API limit for the DMS 205-a, and the DMS 205-a may calculate one or more thresholds based on the API limit for the DMS 205-a (e.g., the DMS API threshold 225). For example, the thresholds may be a percentage of the API limits (e.g., 95%) provided by the customer 215-a to provide a buffer with respect to the API limits. In some examples, the thresholds may be equal to the API limits provided by the customer 215-a. For each customer 215-a (e.g., for each organization for which the DMS 205-a-a provides backup and recovery services), the DMS 205-a may record a limit set by the customer. In a table (e.g., a saasapps_organization table), the DMS 205-a may record metadata defining the API limits for API types (e.g., all API types). For example, the DMS 205-a may be allocated 20 percent of a first API type and 50 percent of a second API type (e.g., “apiLimits”: {“rest”: 20, “bulkV2”: 50}). Additionally, or alternatively, the customer 215-a may edit the API limits (e.g., via the user interface).

One or more jobs of the DMS 205-a may perform one or more API calls 305. For example, a first job may perform the API call 305-a. The first job may periodically publish or report API calls 305 performed by the first job to an API usage table. Each entry in the API usage table may follow a schema to record (e.g., the schema shown in Table 1). In Table 1, PRI refers to a primary key, and MUL refers to a key based on multi-value index.

TABLE 1

| Field | Type | Null | Key | Default | Extra |
|---|---|---|---|---|---|
| id | bigint | NO | Primary | NULL | auto_{—} |
| | unsigned | | (PRI) | | increment |
| saas_app_type | varchar(32) | NO | NO | | |
| org_id | char(36) | NO | MUL | NULL | |
| api_timestamp | datetime | NO | PRI | NULL | |
| api_type | varchar(36) | NO | MUL | NULL | |
| usage_count | integer (int) | NO | | NULL | |
| source | varchar(64) | YES | | NULL | |
| debug_info | json | YES | | NULL | |
| snappable_id | char(36) | YES | MUL | NULL | |

Each job may record a timestamp (api_timestamp) when an API was called and how many APIs calls were performed (usage_count). Additionally, or alternatively, each job may record additional metadata such as an identifier of the record (id), an indication of the SaaS application (saas_app_type), an indication of the customer 215-a or the organization (org_id), an indication of a type of API call (api_type), a source of the API call (source), debug information (debug_info), or an identifier of a snapshot or snappable associated with the API calls (snapable_id).

The DMS 205-a may use the API usage table to query a total quantity of API calls used by the DMS 205-a on behalf of a customer 215-a in a rolling duration (e.g., the last 24 hours). Each job may record the API calls used into the API usage table (e.g., RSC table) periodically (e.g., after every 10 mins) or at the end of the job.

The DMS 205-a may prune the API usage table as old entries (e.g., beyond the threshold time period for which the API limit(s) are applicable) may not be useful since such entries no longer contribute to the rolling duration. For example, the DMS 205-a may perform database table partitioning based on the timestamp to garbage collect any data older than a threshold (e.g., seven days).

At the start of each job, the DMS 205-a may schedule the job based on quantities of API calls being less than respective thresholds, as described with reference to FIG. 2. For example, the DMS 205-a may obtain the current API limits for the customer 215-a on the SaaS application. The DMS 205-a may remove all API types that are beyond a usage limit for the customer 215-a (e.g., beyond a global usage limit of 95%). The DMS 205-a may remove all API types that are beyond a usage limit for the DMS 205-a (e.g., beyond a global usage limit of 95%). For example, the DMS 205-a may find all API types where an API call usage of that API type by the DMS 205-a is less than a DMS API threshold (e.g., less than 95% of an API limit of the DMS 205-a), and an overall API usage for the customer 215-a for that API type is less than a customer API threshold (e.g., less than 95% of an overall limit for the customer 215-a on the SaaS application 210-a). The DMS 205-a may collect all the API types that are available and pass the collected API types to a job configuration of the job so that the job may use the available APIs.

In some examples, the DMS 205-a may provide one or more parameters to the job when the job is scheduled. The job configuration may include the one or more parameters, which may indicate the API types that are available. In some examples, the DMS 205-a may pass an indication of the API types that are available to a job configuration manager of the DMS 205-a. The job configuration manager may configure or schedule jobs so that a job may be scheduled that may use the available APIs. For example, the job configuration manager may schedule jobs that use API types that are currently available.

In the distributed environment future API call usage by any one particular job may be unknown at the time the job is scheduled. Even if the quantities of API calls are less than respective thresholds when the job is started, the DMS 205-a may exhaust the API calls in the middle of the job. Accordingly, the DMS 205-a may determine if an API call policy is satisfied for an API call prior to performing the API call. For example, the DMS 205-a may perform API usage tracking while jobs are executing, and the DMS 205-a may pause a job in execution if the API limit is reached during execution of the job. For example, at the start of each API call, in accordance with the API call policy for the DMS 205-a for the particular SaaS application and the particular customer, the job may check if the API limits are adhered to or not. If the API limits are not adhered to, the DMS 205-a may pause the job. To determine if the API limits are adhered to, the DMS 205-a may obtain a cached API usage for the customer 215-a on the SaaS application 210-a and a current API usage from the data store at the DMS 205-a periodically (e.g., every 10 mins). For example, the SaaS application 210-a may support an API call to obtain API call usage for the customer 215-a. The DMS 205-a may periodically perform an API call to the SaaS application 210-a to obtain the API call usage for the customer 215-a. The DMS 205-a may store an indication of the API call usage for the customer 215-a in a cache entry.

In an illustrative example, at 320, the DMS 205-a may attempt to schedule a job. the DMS 205-a may obtain a quantity of API calls used by the DMS 205-a during the rolling time period 315-a, and a quantity of API calls used by the customer 215-a during the rolling time period 315-a. The DMS 205-a may schedule the job based on the quantity of API calls used by the DMS 205-a being less than a DMS API threshold and/or the quantity of API calls used by the customer 215-a being less than a customer API threshold. As described herein, the DMS API threshold may be a percentage of an API limit for the DMS 205-a, and the customer API threshold may be a percentage of an API limit for the customer 215-a.

At 325, the job may attempt to perform an API call 305-b. The job may obtain (e.g., from the cached API usage information) the quantity of API calls used by the DMS 205-a during the rolling time period 315-b. The job may obtain (e.g., from the cached API usage information) a quantity of API calls used by the customer 215-a during the rolling time period 315-b. In some examples, the DMS 205-a may pause the job based on a quantity of API calls used by the DMS 205-a exceeding the API limit for the DMS 205-a. In some examples, the DMS may pause the job based on a quantity of API calls used by the customer 215-a exceeding the API limit for the customer 215-a.

At 330, the DMS 205-a may attempt to resume the job. In some examples, the DMS 205-a may determine whether a quantity of API calls used by the DMS 205-a during a rolling time period 315-c satisfies a job resume threshold for the DMS 205-a. In some examples, the DMS 205-a may determine whether a quantity of API calls used by the customer 215-a during the rolling time period 315-c satisfies a job resume threshold for the customer 215-a. If the job resume threshold is satisfied, the DMS 205-a may resume the job, and the job may perform the API call 305-b.

In some examples, the DMS 205-a may track the API usage of the customer 215-a, and the DMS 205-a may not track the API usage of the DMS 205-a. The DMS 205-a may schedule jobs 245 such that a quantity of API calls used by the customer 215 does not exceed the customer API threshold 230, and the DMS 205-a may pause jobs 245 such that the quantity of API calls used by the customer 215-a does not exceed the API limit for the customer 215-a (e.g., regardless of the quantity of API calls used by the DMS 205-a). In some examples, the DMS 205-a may track the API call usage of the DMS 205-a, and the DMS 205-a may not track the API usage of the customer 215-a. For example, the SaaS application may not support an API call to obtain the API usage of the customer 215-a. The DMS 205-a may schedule jobs 245 such that a quantity of API calls used by the DMS 205-a does not exceed the DMS API threshold 225, and the DMS 205-a may pause jobs 245 such that the quantity of API calls used by the DMS 205-a does not exceed the API limit for the DMS 205-a (e.g., regardless of the quantity of API calls used by the customer 215-a).

Although described in the context of an SaaS application, it should be understood that the techniques described herein may apply to any software platform that limits a quantity of API calls that a customer may use (e.g., to access data on the software platform). For example, the techniques described herein may apply to a software platform of any payment or licensing scheme.

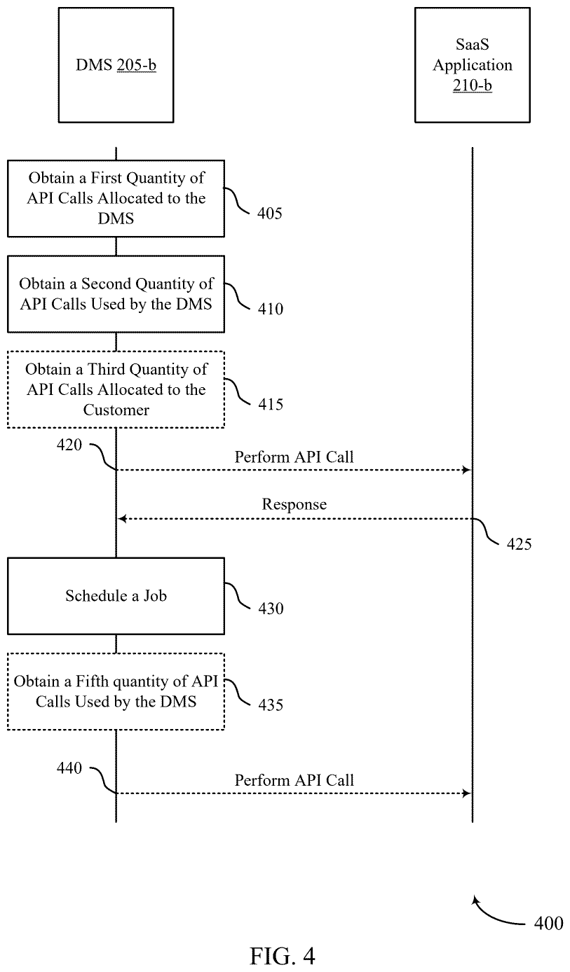

FIG. 4 shows an example of a process flow 400 that supports an API limit based job scheduler in accordance with aspects of the present disclosure. The process flow 400 may implement or be implemented by aspects of FIGS. 1-3. For example, the process flow 400 may include a DMS 205-b and an SaaS application 210-b, which may be examples of a DMS 205 or an SaaS application 210 as described herein with reference to FIGS. 1-3. The SaaS application 210-b may be an example of a software platform as described herein.

At 405, the DMS 205-b may obtain an indication of a first quantity of API calls allocated to the DMS in association with a customer of the DMS for the SaaS application 210-b over a rolling duration.

At 410, the DMS 205-b may obtain, from a data store accessible to the DMS 205-b, an indication of a second quantity of API calls used by the DMS 205-b during a first rolling time period of the rolling duration. For example, the data store may be a data store 240 as described herein.

At 430, the DMS 205-b may schedule a job associated with backup or recovery service for the SaaS application 210-b in association with the customer based on the second quantity of API calls being less than a first threshold quantity. The first threshold quantity may be based on the first quantity of API calls. In some cases, the first threshold quantity may be a percentage of the first quantity.

In some examples, at 415, the DMS 205-b may obtain an indication of a third quantity of API calls allocated to the customer for the SaaS application 210-b over the rolling duration.

In some examples, at 420, the DMS 205-b may perform an API call to the SaaS application 210-b that requests the indication of a fourth quantity of API calls used by the customer during the first rolling time period. In some examples, at 425, the DMS 205-b may obtain an indication of the fourth quantity of API calls used by the customer during the first rolling time period. For example, the DMS 205-b may receive, from the SaaS application 210-b, a response to the API call that includes the indication of the fourth quantity of API calls. The indication at 425 may be responsive to the API call at 420.

In some examples, the DMS 205-b may obtain an indication of an update to the first quantity of API calls or the third quantity of API calls, and scheduling the job at 430 may be based on the update to the first quantity of API calls or the third quantity of API calls.

At 435, the DMS 205-b may obtain, from the data store accessible to the DMS 205-b and during an execution of the job, an indication of a fifth quantity of API calls used by the DMS 205-b during a second rolling time period of the rolling duration. In some cases, the DMS 205-b may obtain, during the execution of the job, an indication of a sixth quantity of API calls used by the customer during the second rolling time period. At 440, the job of the DMS 205-b may perform an API call based on the fifth quantity of API calls being less than the first quantity of API calls. In some cases, the DMS 205-b may perform, by the job, the API call based on the sixth quantity of API calls being less than the third quantity. In some cases, the job of the DMS 205-b may output, based on performing the API call, an API call update including an indication of the API call and metadata associated with the API call to the data store. The metadata may include a type of API call, a type of the SaaS application 210-b, a customer identifier associated with the customer, or any combination thereof. The API call update may be output periodically and include multiple indications corresponding to multiple API calls performed within a duration and second metadata associated with the multiple API calls. In some cases, the DMS 205-b may pause the job prior to performing a second API call based on the fifth quantity of API calls being greater than or equal to the first threshold quantity or the sixth quantity of API calls being greater than or equal to a second threshold quantity. The second threshold quantity may be based on the third quantity. In some cases, the DMS 205-b may obtain, from the data store accessible to the DMS 205-b and while the job is paused, an indication of a seventh quantity of API calls used by the DMS during a third rolling time period of the rolling duration. The third rolling time period may be later in time than the second rolling time period. The DMS 205-b may obtain an indication of an eighth quantity of API calls used by the customer during the third rolling time period. The DMS 205-b may resume the job based on the seventh quantity of API calls being less than the first threshold quantity and the eighth quantity of API calls being less than the second threshold quantity.

In some cases, the first quantity of API calls, the second quantity of API calls, and the first threshold quantity may be associated with a first type of API call of a plurality of types of API calls associated with the SaaS application 210-b. The DMS 205-b may obtain an indication of a third quantity of API calls associated with a second type of API call allocated to the DMS 205-b in association with the customer of the DMS 205-b for the SaaS application 210-b over the first rolling time period. The second type of API call may be one of the multiple types of API calls associated with the SaaS application 210-b. The DMS 205-b may obtain, from the data store accessible to the DMS 205-b, an indication of a fourth quantity of API calls associated with the second type of API call used by the DMS 205-b during the first rolling time period. The DMS 205-b may output, to the job, an indication that the API calls associated with the second type of API call are permitted based on the fourth quantity of API calls being less than a second threshold quantity associated with the second type of API calls. The second threshold quantity may be based on the third quantity of API calls.

In some cases, the DMS 205-b may perform, on the data store, a garbage collection procedure to remove entries in the data store older than a threshold age.

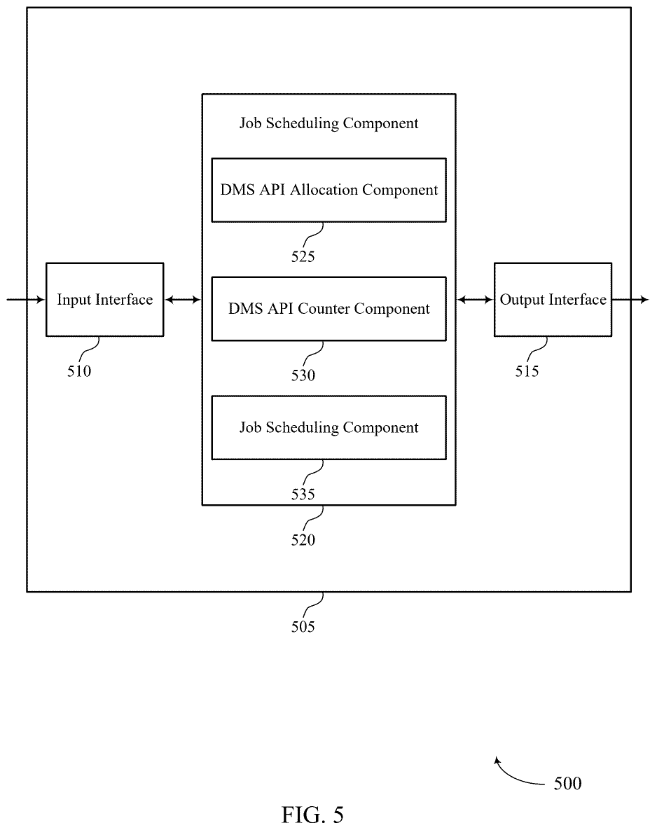

FIG. 5 shows a block diagram 500 of a system 505 that supports an API limit based job scheduler in accordance with aspects of the present disclosure. In some examples, the system 505 may be an example of aspects of one or more components described with reference to FIG. 1, such as a DMS 110. The system 505 may include an input interface 510, an output interface 515, and a job scheduling component 520. The system 505 may also include one or more processors. Each of these components may be in communication with one another (e.g., via one or more buses, communications links, communications interfaces, or any combination thereof).

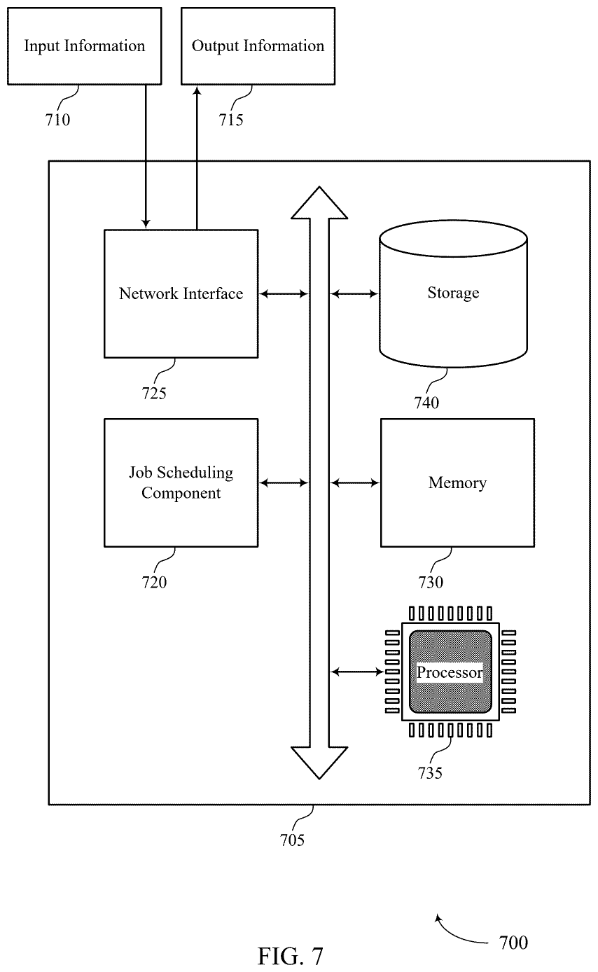

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the job scheduling component 520 to support an API limit based job scheduler. In some cases, the input interface 510 may be a component of a network interface 725 as described with reference to FIG. 7.

The output interface 515 may manage output signaling for the system 505. For example, the output interface 515 may receive signaling from other components of the system 505, such as the job scheduling component 520, and may transmit such output signaling corresponding to (e.g., representative of or otherwise based on) such signaling to other systems or devices. In some cases, the output interface 515 may be a component of a network interface 725 as described with reference to FIG. 7.

For example, the job scheduling component 520 may include a DMS API allocation component 525, a DMS API counter component 530, a job scheduling component 535, or any combination thereof. In some examples, the job scheduling component 520, or various components thereof, may be configured to perform various operations (e.g., receiving, monitoring, transmitting) using or otherwise in cooperation with the input interface 510, the output interface 515, or both. For example, the job scheduling component 520 may receive information from the input interface 510, send information to the output interface 515, or be integrated in combination with the input interface 510, the output interface 515, or both to receive information, transmit information, or perform various other operations as described herein.

The DMS API allocation component 525 may be configured as or otherwise support a means for obtaining, at a DMS, an indication of a first quantity of API calls allocated to the DMS in association with a customer of the DMS for a SaaS application over a rolling duration. The DMS API counter component 530 may be configured as or otherwise support a means for obtaining, from a data store accessible to the DMS, an indication of a second quantity of API calls used by the DMS during a first rolling time period of the rolling duration. The job scheduling component 535 may be configured as or otherwise support a means for scheduling, by the DMS, a job associated with backup or recovery service for the SaaS application in association with the customer based on the second quantity of API calls being less than a first threshold quantity, where the first threshold quantity is based on the first quantity of API calls.

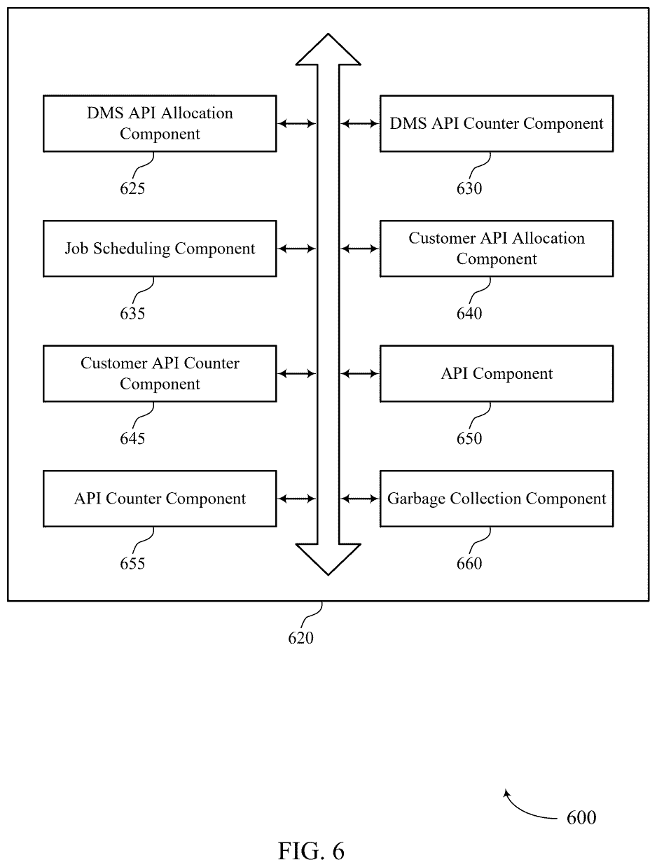

FIG. 6 shows a block diagram 600 of a job scheduling component 620 that supports an API limit based job scheduler in accordance with aspects of the present disclosure. The job scheduling component 620 may be an example of aspects of a job scheduling component or a job scheduling component 520, or both, as described herein. The job scheduling component 620, or various components thereof, may be an example of means for performing (e.g., to cause the job scheduling component 620 to perform) various aspects of an API limit based job scheduler as described herein. For example, the job scheduling component 620 may include a DMS API allocation component 625, a DMS API counter component 630, a job scheduling component 635, a customer API allocation component 640, a customer API counter component 645, an API component 650, an API counter component 655, a garbage collection component 660, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The DMS API allocation component 625 may be configured as or otherwise support a means for obtaining, at a DMS, an indication of a first quantity of API calls allocated to the DMS in association with a customer of the DMS for a SaaS application over a rolling duration. The DMS API counter component 630 may be configured as or otherwise support a means for obtaining, from a data store accessible to the DMS, an indication of a second quantity of API calls used by the DMS during a first rolling time period of the rolling duration. The job scheduling component 635 may be configured as or otherwise support a means for scheduling, by the DMS, a job associated with backup or recovery service for the SaaS application in association with the customer based on the second quantity of API calls being less than a first threshold quantity, where the first threshold quantity is based on the first quantity of API calls.

In some examples, the customer API allocation component 640 may be configured as or otherwise support a means for obtaining, at the DMS, an indication of a third quantity of API calls allocated to the customer for the SaaS application over the rolling duration. In some examples, the customer API counter component 645 may be configured as or otherwise support a means for obtaining an indication of a fourth quantity of API calls used by the customer during the first rolling time period, where scheduling the job further includes scheduling the job based on the fourth quantity of API calls being less than a second threshold quantity, where the second threshold quantity is based on the third quantity.

In some examples, to support obtaining the fourth quantity, the API component 650 may be configured as or otherwise support a means for performing, by the DMS, an API call to the SaaS application that requests the indication of the fourth quantity of API calls. In some examples, to support obtaining the fourth quantity, the API component 650 may be configured as or otherwise support a means for receiving, at the DMS and from the SaaS application, a response to the API call that includes the indication of the fourth quantity of API calls.

In some examples, the DMS API counter component 630 may be configured as or otherwise support a means for obtaining, at the DMS, an indication of an update to the first quantity of API calls or the third quantity of API calls, where scheduling the job is based on the update to the first quantity of API calls or the third quantity of API calls.

In some examples, the DMS API counter component 630 may be configured as or otherwise support a means for obtaining, from the data store accessible to the DMS and during an execution of the job, an indication of a fifth quantity of API calls used by the DMS during a second rolling time period of the rolling duration. In some examples, the API component 650 may be configured as or otherwise support a means for performing, by the job, an API call based on the fifth quantity of API calls being less than the first quantity of API calls.

In some examples, the customer API allocation component 640 may be configured as or otherwise support a means for obtaining, at the DMS, an indication of a third quantity of API calls allocated to the customer for the SaaS application over the rolling duration. In some examples, the customer API counter component 645 may be configured as or otherwise support a means for obtaining, at the DMS and during the execution of the job, an indication of a sixth quantity of API calls used by the customer during the second rolling time period, where performing, by the job, the API call is further based on the sixth quantity of API calls being less than the third quantity.

In some examples, the customer API counter component 645 may be configured as or otherwise support a means for outputting, by the job and based on performing the API call, an API call update including an indication of the API call and metadata associated with the API call to the data store.

In some examples, the metadata includes a type of API call, a type of the SaaS application, a customer identifier associated with the customer, or any combination thereof.

In some examples, the API call update is output periodically and includes a set of multiple indications corresponding to a set of multiple API calls performed within a duration and second metadata associated with the set of multiple API calls.

In some examples, the customer API allocation component 640 may be configured as or otherwise support a means for obtaining, at the DMS, an indication of a third quantity of API calls allocated to the customer for the SaaS application over the rolling duration. In some examples, the API counter component 655 may be configured as or otherwise support a means for obtaining, from the data store accessible to the DMS and during an execution of the job, an indication of a fifth quantity of API calls used by the DMS during a second rolling time period of the rolling duration and an indication of a sixth quantity of API calls used by the customer during the second rolling time period. In some examples, the job scheduling component 635 may be configured as or otherwise support a means for pausing the job prior to performing a second API call based on the fifth quantity of API calls being greater than or equal to the first threshold quantity or the sixth quantity of API calls being greater than or equal to a second threshold quantity, where the second threshold quantity is based on the third quantity.

In some examples, the DMS API counter component 630 may be configured as or otherwise support a means for obtaining, from the data store accessible to the DMS and while the job is paused, an indication of a seventh quantity of API calls used by the DMS during a third rolling time period of the rolling duration, the third rolling time period later in time than the second rolling time period. In some examples, the customer API counter component 645 may be configured as or otherwise support a means for obtaining, at the DMS, an indication of an eighth quantity of API calls used by the customer during the third rolling time period. In some examples, the job scheduling component 635 may be configured as or otherwise support a means for resuming the job based on the seventh quantity of API calls being less than the first threshold quantity and the eighth quantity of API calls being less than the second threshold quantity.

In some examples, the first quantity of API calls, the second quantity of API calls, and the first threshold quantity are associated with a first type of API call of a set of multiple types of API calls associated with the SaaS application.

In some examples, the DMS API allocation component 625 may be configured as or otherwise support a means for obtaining, at the DMS, an indication of a third quantity of API calls associated with a second type of API call allocated to the DMS in association with the customer of the DMS for the SaaS application over the first rolling time period, the second type of API call being one of the set of multiple types of API calls associated with the SaaS application. In some examples, the DMS API counter component 630 may be configured as or otherwise support a means for obtaining, from the data store accessible to the DMS, an indication of a fourth quantity of API calls associated with the second type of API call used by the DMS during the first rolling time period. In some examples, the job scheduling component 635 may be configured as or otherwise support a means for outputting, to the job, an indication that the API calls associated with the second type of API call are permitted based on the fourth quantity of API calls being less than a second threshold quantity associated with the second type of API calls, where the second threshold quantity is based on the third quantity of API calls.

In some examples, the garbage collection component 660 may be configured as or otherwise support a means for performing, at the DMS on the data store, a garbage collection procedure to remove entries in the data store older than a threshold age.

In some examples, the first threshold quantity is a percentage of the first quantity.

FIG. 7 shows a block diagram 700 of a system 705 that supports an API limit based job scheduler in accordance with aspects of the present disclosure. The system 705 may be an example of or include components of a system 505 as described herein. The system 705 may include components for data management, including components such as a job scheduling component 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting an API limit based job scheduler). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the job scheduling component 720 may be configured as or otherwise support a means for obtaining, at a DMS, an indication of a first quantity of API calls allocated to the DMS in association with a customer of the DMS for a SaaS application over a rolling duration. The job scheduling component 720 may be configured as or otherwise support a means for obtaining, from a data store accessible to the DMS, an indication of a second quantity of API calls used by the DMS during a first rolling time period of the rolling duration. The job scheduling component 720 may be configured as or otherwise support a means for scheduling, by the DMS, a job associated with backup or recovery service for the SaaS application in association with the customer based on the second quantity of API calls being less than a first threshold quantity, where the first threshold quantity is based on the first quantity of API calls.

By including or configuring the job scheduling component 720 in accordance with examples as described herein, the system 705 may support techniques for an API limit based job scheduler, which may provide one or more benefits such as, for example, improved reliability, improved user experience, among other possibilities.

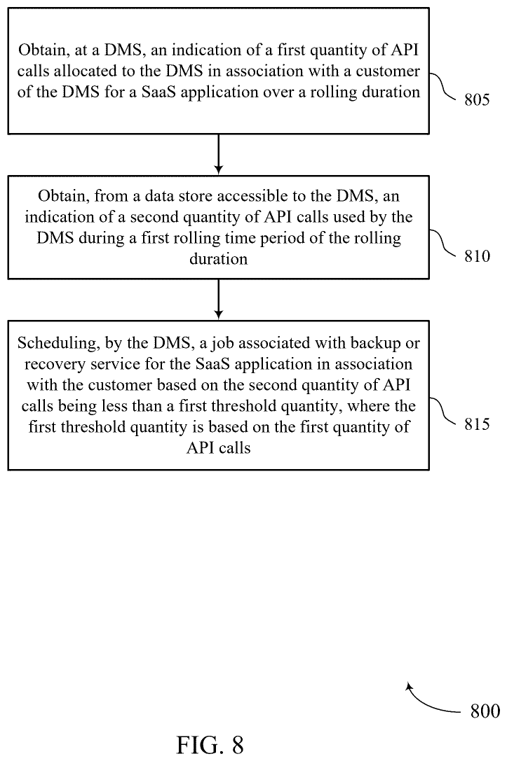

FIG. 8 shows a flowchart illustrating a method 800 that supports an API limit based job scheduler in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include obtaining, at a DMS, an indication of a first quantity of API calls allocated to the DMS in association with a customer of the DMS for a SaaS application over a rolling duration. The operations of 805 may be performed in accordance with examples as disclosed herein. In some examples, aspects of the operations of 805 may be performed by a DMS API allocation component 625.

At 810, the method may include scheduling, by the DMS, a job associated with backup or recovery service for the SaaS application in association with the customer based on the second quantity of API calls being less than a first threshold quantity, where the first threshold quantity is based on the first quantity of API calls. The operations of 810 may be performed in accordance with examples as disclosed herein. In some examples, aspects of the operations of 810 may be performed by a job scheduling component 635.

At 815, the method may include obtaining, from a data store accessible to the DMS, an indication of a second quantity of API calls used by the DMS during a first rolling time period of the rolling duration. The operations of 815 may be performed in accordance with examples as disclosed herein. In some examples, aspects of the operations of 815 may be performed by a DMS API counter component 630.

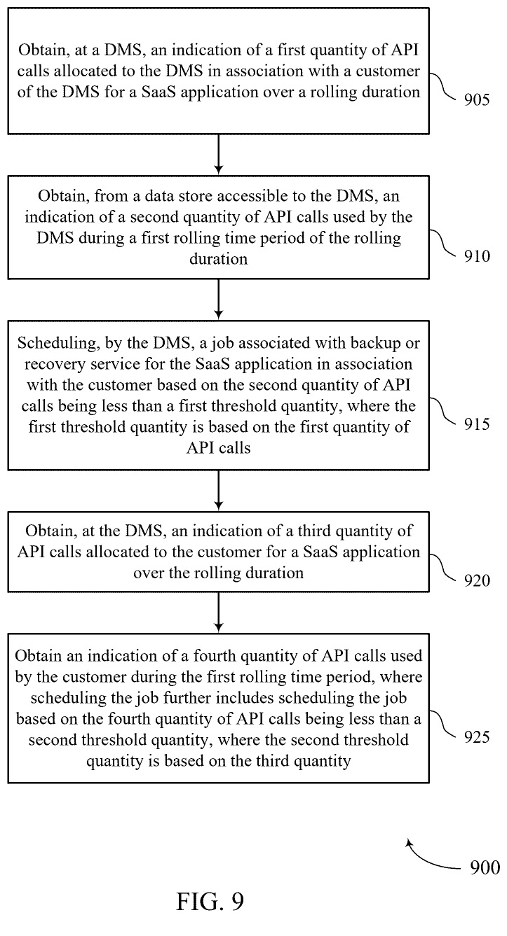

FIG. 9 shows a flowchart illustrating a method 900 that supports an API limit based job scheduler in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include obtaining, at a DMS, an indication of a first quantity of API calls allocated to the DMS in association with a customer of the DMS for a SaaS application over a rolling duration. The operations of 905 may be performed in accordance with examples as disclosed herein. In some examples, aspects of the operations of 905 may be performed by a DMS API allocation component 625.

At 910, the method may include scheduling, by the DMS, a job associated with backup or recovery service for the SaaS application in association with the customer based on the second quantity of API calls being less than a first threshold quantity, where the first threshold quantity is based on the first quantity of API calls. The operations of 910 may be performed in accordance with examples as disclosed herein. In some examples, aspects of the operations of 910 may be performed by a job scheduling component 635.

At 915, the method may include obtaining, from a data store accessible to the DMS, an indication of a second quantity of API calls used by the DMS during a first rolling time period of the rolling duration. The operations of 915 may be performed in accordance with examples as disclosed herein. In some examples, aspects of the operations of 915 may be performed by a DMS API counter component 630.

At 920, the method may include obtaining, at the DMS, an indication of a third quantity of API calls allocated to the customer for the SaaS application over the rolling duration. The operations of 920 may be performed in accordance with examples as disclosed herein. In some examples, aspects of the operations of 920 may be performed by a customer API allocation component 640.

At 925, the method may include obtaining an indication of a fourth quantity of API calls used by the customer during the first rolling time period, where scheduling the job further includes scheduling the job based on the fourth quantity of API calls being less than a second threshold quantity, where the second threshold quantity is based on the third quantity. The operations of 925 may be performed in accordance with examples as disclosed herein. In some examples, aspects of the operations of 925 may be performed by a customer API counter component 645.

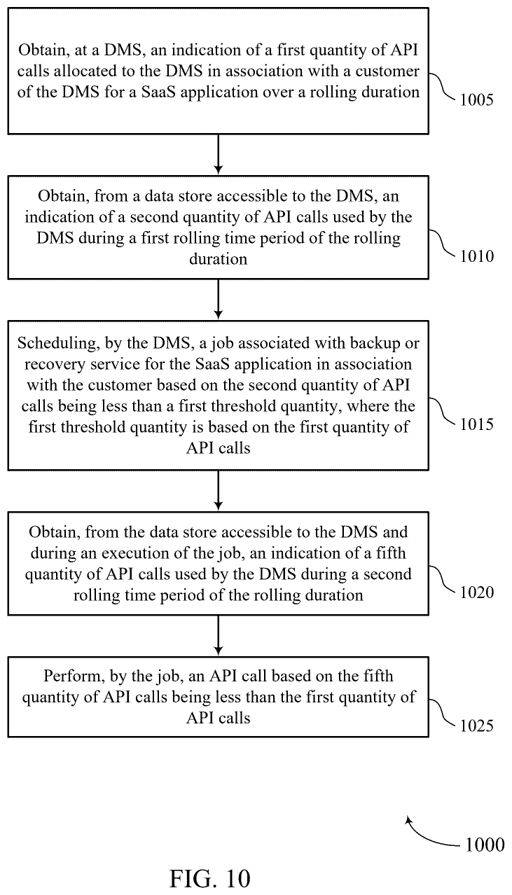

FIG. 10 shows a flowchart illustrating a method 1000 that supports an API limit based job scheduler in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include obtaining, at a DMS, an indication of a first quantity of API calls allocated to the DMS in association with a customer of the DMS for a SaaS application over a rolling duration. The operations of 1005 may be performed in accordance with examples as disclosed herein. In some examples, aspects of the operations of 1005 may be performed by a DMS API allocation component 625.

At 1010, the method may include scheduling, by the DMS, a job associated with backup or recovery service for the SaaS application in association with the customer based on the second quantity of API calls being less than a first threshold quantity, where the first threshold quantity is based on the first quantity of API calls. The operations of 1010 may be performed in accordance with examples as disclosed herein. In some examples, aspects of the operations of 1010 may be performed by a job scheduling component 635.

At 1015, the method may include obtaining, from a data store accessible to the DMS, an indication of a second quantity of API calls used by the DMS during a first rolling time period of the rolling duration. The operations of 1015 may be performed in accordance with examples as disclosed herein. In some examples, aspects of the operations of 1015 may be performed by a DMS API counter component 630.

At 1020, the method may include obtaining, from the data store accessible to the DMS and during an execution of the job, an indication of a fifth quantity of API calls used by the DMS during a second rolling time period of the rolling duration. The operations of 1020 may be performed in accordance with examples as disclosed herein. In some examples, aspects of the operations of 1020 may be performed by a DMS API counter component 630.

At 1025, the method may include performing, by the job, an API call based on the fifth quantity of API calls being less than the first quantity of API calls. The operations of 1025 may be performed in accordance with examples as disclosed herein. In some examples, aspects of the operations of 1025 may be performed by an API component 650.

The following provides an overview of aspects of the present disclosure:

Aspect 1: A method, comprising: obtaining, at a DMS, an indication of a first quantity of API calls allocated to the DMS in association with a customer of the DMS for a SaaS application over a rolling duration; obtaining, from a data store accessible to the DMS, an indication of a second quantity of API calls used by the DMS during a first rolling time period of the rolling duration; and scheduling, by the DMS, a job associated with backup or recovery service for the SaaS application in association with the customer based at least in part on the second quantity of API calls being less than a first threshold quantity, wherein the first threshold quantity is based at least in part on the first quantity of API calls.

Aspect 2: The method of aspect 1, further comprising: obtaining, at the DMS, an indication of a third quantity of API calls allocated to the customer for the SaaS application over the rolling duration; and obtaining an indication of a fourth quantity of API calls used by the customer during the first rolling time period, wherein scheduling the job further comprises scheduling the job based at least in part on the fourth quantity of API calls being less than a second threshold quantity, wherein the second threshold quantity is based at least in part on the third quantity.

Aspect 3: The method of aspect 2, wherein obtaining the fourth quantity comprises: performing, by the DMS, an API call to the SaaS application that requests the indication of the fourth quantity of API calls; and receiving, at the DMS and from the SaaS application, a response to the API call that includes the indication of the fourth quantity of API calls.

Aspect 4: The method of any of aspects 2 through 3, further comprising: obtaining, at the DMS, an indication of an update to the first quantity of API calls or the third quantity of API calls, wherein scheduling the job is based at least in part on the update to the first quantity of API calls or the third quantity of API calls.

Aspect 5: The method of any of aspects 1 through 4, further comprising: obtaining, from the data store accessible to the DMS and during an execution of the job, an indication of a fifth quantity of API calls used by the DMS during a second rolling time period of the rolling duration; and performing, by the job, an API call based at least in part on the fifth quantity of API calls being less than the first quantity of API calls.

Aspect 6: The method of aspect 5, further comprising: obtaining, at the DMS, an indication of a third quantity of API calls allocated to the customer for the SaaS application over the rolling duration; and obtaining, at the DMS and during the execution of the job, an indication of a sixth quantity of API calls used by the customer during the second rolling time period, wherein performing, by the job, the API call is further based at least in part on the sixth quantity of API calls being less than the third quantity.

Aspect 7: The method of any of aspects 5 through 6, further comprising: outputting, by the job and based at least in part on performing the API call, an API call update comprising an indication of the API call and metadata associated with the API call to the data store.

Aspect 8: The method of aspect 7, wherein the metadata comprises a type of API call, a type of the SaaS application, a customer identifier associated with the customer, or any combination thereof.

Aspect 9: The method of any of aspects 7 through 8, wherein the API call update is output periodically and comprises a plurality of indications corresponding to a plurality of API calls performed within a duration and second metadata associated with the plurality of API calls.

Aspect 10: The method of any of aspects 1 through 9, further comprising: obtaining, at the DMS, an indication of a third quantity of API calls allocated to the customer for the SaaS application over the rolling duration; obtaining, from the data store accessible to the DMS and during an execution of the job, an indication of a fifth quantity of API calls used by the DMS during a second rolling time period of the rolling duration and an indication of a sixth quantity of API calls used by the customer during the second rolling time period; and pausing the job prior to performing a second API call based at least in part on the fifth quantity of API calls being greater than or equal to the first threshold quantity or the sixth quantity of API calls being greater than or equal to a second threshold quantity, wherein the second threshold quantity is based at least in part on the third quantity.

Aspect 11: The method of aspect 10, further comprising: obtaining, from the data store accessible to the DMS and while the job is paused, an indication of a seventh quantity of API calls used by the DMS during a third rolling time period of the rolling duration, the third rolling time period later in time than the second rolling time period; obtaining, at the DMS, an indication of an eighth quantity of API calls used by the customer during the third rolling time period; and resuming the job based at least in part on the seventh quantity of API calls being less than the first threshold quantity and the eighth quantity of API calls being less than the second threshold quantity.

Aspect 12: The method of any of aspects 1 through 11, wherein the first quantity of API calls, the second quantity of API calls, and the first threshold quantity are associated with a first type of API call of a plurality of types of API calls associated with the SaaS application.

Aspect 13: The method of aspect 12, further comprising: obtaining, at the DMS, an indication of a third quantity of API calls associated with a second type of API call allocated to the DMS in association with the customer of the DMS for the SaaS application over the first rolling time period, the second type of API call being one of the plurality of types of API calls associated with the SaaS application; obtaining, from the data store accessible to the DMS, an indication of a fourth quantity of API calls associated with the second type of API call used by the DMS during the first rolling time period; and outputting, to the job, an indication that the API calls associated with the second type of API call are permitted based at least in part on the fourth quantity of API calls being less than a second threshold quantity associated with the second type of API calls, wherein the second threshold quantity is based at least in part on the third quantity of API calls.

Aspect 14: The method of any of aspects 1 through 13, further comprising: performing, at the DMS on the data store, a garbage collection procedure to remove entries in the data store older than a threshold age.

Aspect 15: The method of any of aspects 1 through 14, wherein the first threshold quantity is a percentage of the first quantity.

Aspect 16: An apparatus comprising one or more memories storing processor-executable code, and one or more processors coupled with the one or more memories and individually or collectively operable to execute the code to cause the apparatus to perform a method of any of aspects 1 through 15.

Aspect 17: An apparatus comprising at least one means for performing a method of any of aspects 1 through 15.

Aspect 18: A non-transitory computer-readable medium storing code the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining, at a data management system (DMS), an indication of a first quantity of application programming interface (API) calls allocated to the DMS in association with a customer of the DMS for a software-as-a-service (SaaS) application over a rolling duration;
obtaining, from a data store accessible to the DMS, an indication of a second quantity of API calls used by the DMS during a first rolling time period of the rolling duration; and
scheduling, by the DMS, a job associated with backup or recovery service for the SaaS application in association with the customer based at least in part on the second quantity of API calls being less than a first threshold quantity, wherein the first threshold quantity is based at least in part on the first quantity of API calls.

2. The method of claim 1, further comprising:
obtaining, at the DMS, an indication of a third quantity of API calls allocated to the customer for the SaaS application over the rolling duration; and
obtaining an indication of a fourth quantity of API calls used by the customer during the first rolling time period, wherein scheduling the job further comprises scheduling the job based at least in part on the fourth quantity of API calls being less than a second threshold quantity, wherein the second threshold quantity is based at least in part on the third quantity.

3. The method of claim 2, wherein obtaining the fourth quantity comprises:
performing, by the DMS, an API call to the SaaS application that requests the indication of the fourth quantity of API calls; and
receiving, at the DMS and from the SaaS application, a response to the API call that includes the indication of the fourth quantity of API calls.

4. The method of claim 2, further comprising:
obtaining, at the DMS, an indication of an update to the first quantity of API calls or the third quantity of API calls, wherein scheduling the job is based at least in part on the update to the first quantity of API calls or the third quantity of API calls.

5. The method of claim 1, further comprising:
obtaining, from the data store accessible to the DMS and during an execution of the job, an indication of a fifth quantity of API calls used by the DMS during a second rolling time period of the rolling duration; and
performing, by the job, an API call based at least in part on the fifth quantity of API calls being less than the first quantity of API calls.

6. The method of claim 5, further comprising:
obtaining, at the DMS, an indication of a third quantity of API calls allocated to the customer for the SaaS application over the rolling duration; and
obtaining, at the DMS and during the execution of the job, an indication of a sixth quantity of API calls used by the customer during the second rolling time period, wherein performing, by the job, the API call is further based at least in part on the sixth quantity of API calls being less than the third quantity.

7. The method of claim 5, further comprising:
outputting, by the job and based at least in part on performing the API call, an API call update comprising an indication of the API call and metadata associated with the API call to the data store.

8. The method of claim 7, wherein the metadata comprises a type of API call, a type of the SaaS application, a customer identifier associated with the customer, or any combination thereof.

9. The method of claim 7, wherein the API call update is output periodically and comprises a plurality of indications corresponding to a plurality of API calls performed within a duration and second metadata associated with the plurality of API calls.

10. The method of claim 1, further comprising:
obtaining, at the DMS, an indication of a third quantity of API calls allocated to the customer for the SaaS application over the rolling duration;
obtaining, from the data store accessible to the DMS and during an execution of the job, an indication of a fifth quantity of API calls used by the DMS during a second rolling time period of the rolling duration and an indication of a sixth quantity of API calls used by the customer during the second rolling time period; and
pausing the job prior to performing a second API call based at least in part on the fifth quantity of API calls being greater than or equal to the first threshold quantity or the sixth quantity of API calls being greater than or equal to a second threshold quantity, wherein the second threshold quantity is based at least in part on the third quantity.

11. The method of claim 10, further comprising:
obtaining, from the data store accessible to the DMS and while the job is paused, an indication of a seventh quantity of API calls used by the DMS during a third rolling time period of the rolling duration, the third rolling time period later in time than the second rolling time period;
obtaining, at the DMS, an indication of an eighth quantity of API calls used by the customer during the third rolling time period; and
resuming the job based at least in part on the seventh quantity of API calls being less than the first threshold quantity and the eighth quantity of API calls being less than the second threshold quantity.

12. The method of claim 1, wherein the first quantity of API calls, the second quantity of API calls, and the first threshold quantity are associated with a first type of API call of a plurality of types of API calls associated with the SaaS application.

13. The method of claim 12, further comprising:
obtaining, at the DMS, an indication of a third quantity of API calls associated with a second type of API call allocated to the DMS in association with the customer of the DMS for the SaaS application over the first rolling time period, the second type of API call being one of the plurality of types of API calls associated with the SaaS application;
obtaining, from the data store accessible to the DMS, an indication of a fourth quantity of API calls associated with the second type of API call used by the DMS during the first rolling time period; and
outputting, to the job, an indication that the API calls associated with the second type of API call are permitted based at least in part on the fourth quantity of API calls being less than a second threshold quantity associated with the second type of API calls, wherein the second threshold quantity is based at least in part on the third quantity of API calls.

14. The method of claim 1, further comprising:
performing, at the DMS on the data store, a garbage collection procedure to remove entries in the data store older than a threshold age.

15. The method of claim 1, wherein the first threshold quantity is a percentage of the first quantity.

16. An apparatus, comprising:
one or more memories storing processor-executable code; and
one or more processors coupled with the one or more memories and individually or collectively operable to execute the code to cause the apparatus to:
obtain, at a data management system (DMS), an indication of a first quantity of application programming interface (API) calls allocated to the DMS in association with a customer of the DMS for a software-as-a-service (SaaS) application over a rolling duration;
obtain, from a data store accessible to the DMS, an indication of a second quantity of API calls used by the DMS during a first rolling time period of the rolling duration; and
schedule, by the DMS, a job associated with backup or recovery service for the SaaS application in association with the customer based at least in part on the second quantity of API calls being less than a first threshold quantity, wherein the first threshold quantity is based at least in part on the first quantity of API calls.

17. The apparatus of claim 16, wherein the one or more processors are individually or collectively further operable to execute the code to cause the apparatus to:
obtain, at the DMS, an indication of a third quantity of API calls allocated to the customer for the SaaS application over the rolling duration; and
obtain an indication of a fourth quantity of API calls used by the customer during the first rolling time period, wherein scheduling the job further comprises scheduling the job based at least in part on the fourth quantity of API calls being less than a second threshold quantity, wherein the second threshold quantity is based at least in part on the third quantity.

18. The apparatus of claim 17, wherein, to obtain the fourth quantity, the one or more processors are individually or collectively operable to execute the code to cause the apparatus to:
perform, by the DMS, an API call to the SaaS application that requests the indication of the fourth quantity of API calls; and
receive, at the DMS and from the SaaS application, a response to the API call that includes the indication of the fourth quantity of API calls.

19. The apparatus of claim 16, wherein the one or more processors are individually or collectively further operable to execute the code to cause the apparatus to:
obtain, from the data store accessible to the DMS and during an execution of the job, an indication of a fifth quantity of API calls used by the DMS during a second rolling time period of the rolling duration; and
perform, by the job, an API call based at least in part on the fifth quantity of API calls being less than the first quantity of API calls.

20. A non-transitory computer-readable medium storing code, the code comprising instructions executable by one or more processors to:
obtain, at a data management system (DMS), an indication of a first quantity of application programming interface (API) calls allocated to the DMS in association with a customer of the DMS for a software-as-a-service (SaaS) application over a rolling duration;
obtain, from a data store accessible to the DMS, an indication of a second quantity of API calls used by the DMS during a first rolling time period of the rolling duration; and
schedule, by the DMS, a job associated with backup or recovery service for the SaaS application in association with the customer based at least in part on the second quantity of API calls being less than a first threshold quantity, wherein the first threshold quantity is based at least in part on the first quantity of API calls.
